(19) United States
(12) Patent Application Publication
(10) Pub. No.: US 2005/0135675 A1
(43) Pub. Date: Jun. 23, 2005

(54) Simulation method for makeup trial and the device thereof

(75) Inventors: Tse-Min Chen, Sindian City (TW); Su-Cheong Mac, Taipei City (TW)

Correspondence Address: BACON & THOMAS, PLLC, 625 SLATERS LANE, FOURTH FLOOR, ALEXANDRIA, VA, 22314, US

(73) Assignee: Institute For Information Industry, Taipei (TW)

(21) Appl. No.: 10/851,058

(22) Filed: May 24, 2004

(30) Foreign Application Priority Data
Dec. 19, 2003 (TW) 092136282

(51) Int. Cl. G06K 9/00; G09G 5/00

(52) U.S. Cl. 382/162; 345/582

(57) ABSTRACT

A simulation method for makeup trial and the device thereof are disclosed, which utilize an image sensor and a deep sensor to establish a 3D image according to a target image of a user and a profile signal, such as the lips, eyes or the entire face, and provide makeup data for the makeup product. A user can select a corresponding makeup product using a touch panel. The simulation device for makeup trial reads makeup material data and application skill information via a network or a makeup data extension card, and displays a makeup post-application image on a display module. The present invention is capable of immediately calculating makeup effects when the user turns his or her head.

### BACKGROUND OF THE INVENTION

1. Field of the Invention

The present invention relates to a simulation method for makeup trial and the method thereof, and more particularly, relates to the technical field of image extracting in combination with image processing to provide virtual images of makeup application.

2. Description of the Related Art

People naturally enjoy improving their appearance. Therefore, many companies provide a variety of skin care and makeup products to consumers. In general, consumers prefer applying the makeup on themselves to see the results or effects, and so decide if they like the makeup. However, since such determinations require that the consumer personally apply the makeup, if he or she wants to try several different products at the same time, he or she must repetitively clean off the old makeup to try out the effects offered by the new product.

With improvements in the field of information technology, there now exist various simulation devices for makeup trials. For example, in a makeup shopping website, a plurality of facial samples are provided for the consumer, and the consumer then selects makeup to perform an imaging process upon the selected facial sample to obtain a makeup post-application image. However, this facial sample is not the consumer's actual face, and so is unsatisfactory.

Another prior art technique requires the users to upload digital photos of themselves to a beauty or makeup company website via a mobile phone or other devices. The websites apply image processing techniques, utilizing the feature parameters of the product, to modify the uploaded photos. However, the users are only able to provide 2D photos, and so the makeup post-application image cannot provide a 3D result. Furthermore, transmission of the digital photos gives rise to consumer privacy concerns, or may be limited by network bandwidth.

Therefore, it is desirable to provide a simulation method for makeup trial and its device to mitigate and/or obviate the aforementioned problems.

### SUMMARY OF THE INVENTION

A main objective of the present invention is to provide a simulation method for makeup trial and the method thereof, which employs an image sensor and a deep sensor to generate a 3D image according to a target image of a user, and then utilizes a makeup parameter selected by the user to present a 3D makeup post-application image of the target image, thereby reducing sampling costs.

Another objective of the present invention is to provide a simulation method for makeup trial and the method thereof that immediately calculates a 3D makeup post-application image for a target image according to the variation of viewing angles of the user.

A further objective of the present invention is to provide a simulation method for makeup trial and the method thereof for simulating a makeup application process for a user that avoids both potential invasions of privacy and limitations imposed by network bandwidths.

A much further objective of the present invention is to provide a simulation method for makeup trial and the method thereof that employs a portable communications platform, and which combines digital orientation and object sensing techniques, to provide a hardware and software operating process.

The simulation method for makeup trial of the present invention includes the steps of: extracting image parameters and profile parameters of a target image; analyzing the image parameters and the profile parameters to obtain a 3D image and profiles information such as lip profile or eye profile; receiving an input command to combine a makeup parameter with the target image, the makeup parameter defining a makeup effect; extracting a setting for the makeup parameter; performing an image processing operation to the 3D image by utilizing the texture information and the makeup parameter to obtain a makeup post-application image; and displaying the makeup post-application image.

The simulation device for makeup trail of the present invention includes: a display module; a sensor module for extracting image parameters and profile parameters of a target image; an input module for inputting a command to combine a makeup parameter with the target image, the makeup parameter defining a makeup effect; a microprocessor for analyzing the image parameters and the profile parameters to obtain a 3D image and texture information, for performing an image processing operation by utilizing the 3D image, the texture information and the makeup parameter to obtain a makeup post-application image, and for displaying the makeup post-application image on the display module.

The present invention reads the setting of a makeup parameter from a remote makeup database accessed through a network, or reads the setting of the makeup parameter from a makeup data extension card from an information device. The device of the present invention simulates the entire face of a user, or a portion of the user's face, depending upon the functionality of the hardware. The present invention is also capable of performing an image processing operation that utilizes a 3D image, texture information, a makeup parameter, and a makeup application skill parameter. The makeup application skill parameter defines makeup application skill information for the related makeup. Moreover, the present invention can immediately provide a corresponding makeup post-application image based upon a viewing angle of the target image.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a practical environment according to an embodiment of the present invention;

FIG. 2 is a schematic drawing of an operational interface of a simulation device for makeup trial according to an embodiment of the present invention;

FIG. 3 is a flowchart for an embodiment of the present invention;

FIG. 4 is a functional block drawing of a sensor module according to an embodiment of the present invention;

FIG. 5 is a schematic drawing of sensing a 3D lip shape according to an embodiment of the present invention; and

FIG. 6 is a schematic drawing of a virtual 3D lip shape.

### DETAILED DESCRIPTION OF THE PREFERRED EMBODIMENT

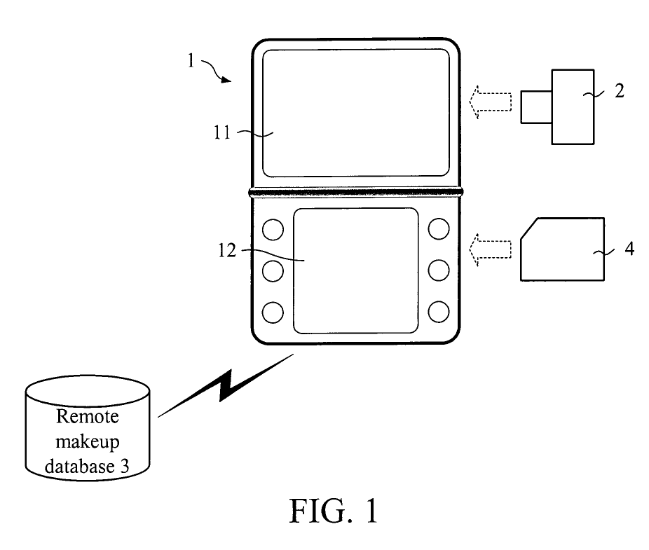

Please refer to FIG. 1. FIG. 1 is a schematic drawing of a practical environment according to an embodiment of the present invention. A simulation device for makeup trial in this embodiment employs a portable information device 1 as a working platform, which may be a smart phone, a PDA (personal digital assistant) or any other similar device, and also employs a plug-in or embedded sensor module 2 for accelerating a feature extraction operation, thereby achieving the function of portable makeup simulation. The simulation device for makeup trial could also utilize a personal computer (PC) as the working platform to expand its total operational capabilities. The portable information device 1 has a network communication function that provides a network connection to a remote makeup database 3 to read settings of a makeup parameter. Alternatively, the portable information device 1 may comprise at least one slot for accepting a makeup data extension card 4, from which may be obtained the settings of the makeup parameter.

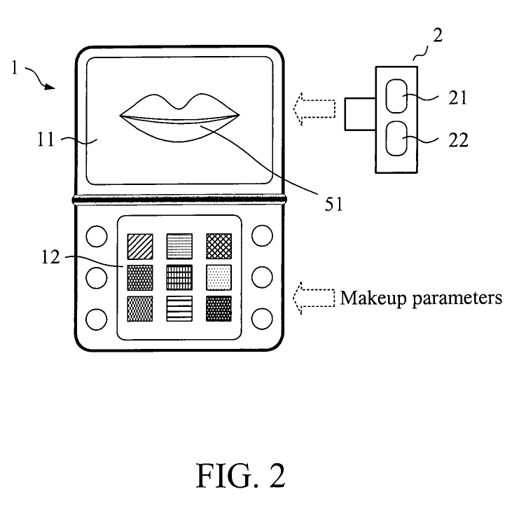

Please refer to FIG. 2. FIG. 2 is a schematic drawing of an operational interface of a simulation device for makeup trial according to the embodiment of the present invention. The simulation device for makeup trial is connected to the plug-in sensor module 2, as shown. The sensor module 2 comprises an image sensor 21 and a deep sensor 22. The image sensor 21 is a CCD (charge coupled device) or a CMOS (complementary metal oxide semiconductor) component, for providing digital signals of a target image 51; the deep sensor 22 is preferred to be an infrared sensor for providing analog signals of the target image 55. A display module 11 of the portable information device 1 is preferred to be an LCD (liquid crystal display). A touch panel serves as an input module 12; a plurality of makeup colors can be shown on the touch panel so that a user may select a color for makeup trial simulation. Furthermore, the display module 11 and the input module 12 may also be combined as a touch-sensitive LCD. Alternatively, a mobile phone having two screens may be employed; one of the screens may be used as the display module 11, and the other may be used as the input device 12.

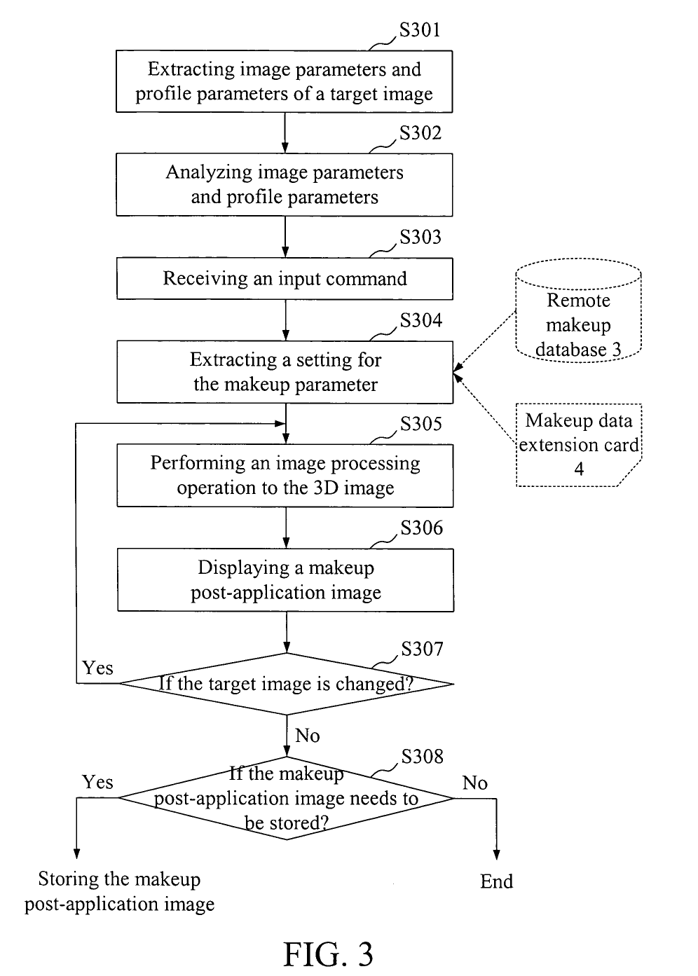

Please refer to FIG. 3. FIG. 3 is a flowchart of the embodiment of the present invention. When a user wants to use the simulation device for makeup trial, the sensor module 2 extracts image parameters and profile parameters corresponding to the target image 51 of the user (step 301). For example, if the user desires to try a particular kind of lipstick, he or she sets a lip image as the target image 51, and the portable information device 1 utilizes a prior art image extraction technique to extract the lip image from the entire facial image; similarly, if the user desires to try a type of eye shadow, the target image would be an eye image. If the portable information device 1 has robust operational abilities, the entire facial image may be used as the target image.

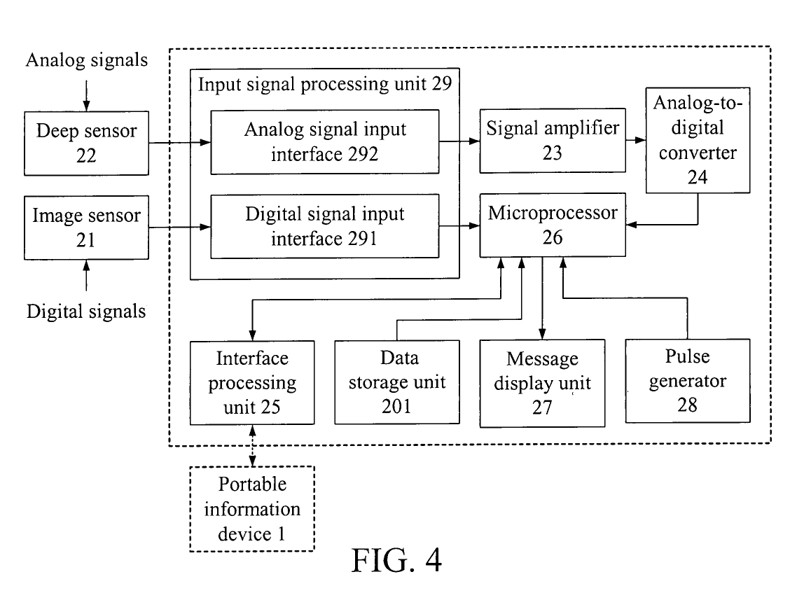

Please refer to FIG. 4. FIG. 4 is a functional block drawing of a sensor module 2 according to the embodiment of the present invention. The image sensor 21 sends digital signals (such as a CCD signal) received from the target image area to a digital signal input interface 291 of an input signal, processing unit 29, wherein a point coordinate description technique is employed to extract a plurality of point coordinate parameters and a partial image extraction technique is employed to extract a partial image (such as a lip image) of the target image 51. The deep sensor 22 provides received analog signals to an analog signal input interface 292. Since all information needs to be converted into corresponding digital signals for subsequent operations, analog signals are sent to a signal amplifier 11 for signal amplification and filtering. These pre-processes extract a plurality of point depth parameters. An analog-to-digital converter 24 then converts analog signals to digital signals; a microprocessor 26 utilizes the converted depth analog signals and the image digital signals to send image parameters and profile parameters to the portable information device 1 via an interface processing unit 25. The interface processing unit 25 utilizes a universal specification interface, such as a PCMCIA, SDIO or CF interface. A message display unit 27, typically an LED (light emitting diode), indicates a movement status from the sensor module 2. Pulse generator 28 is a basic digital circuit element, and so requires no further description. A data storage unit 201 is connected to the microprocessor 26, and may be a flash memory device, or another non-volatility memory device for storing a software program. The sensor module 2 may be provided an independent power source, such as an attached battery, or may be powered by the portable information device 1.

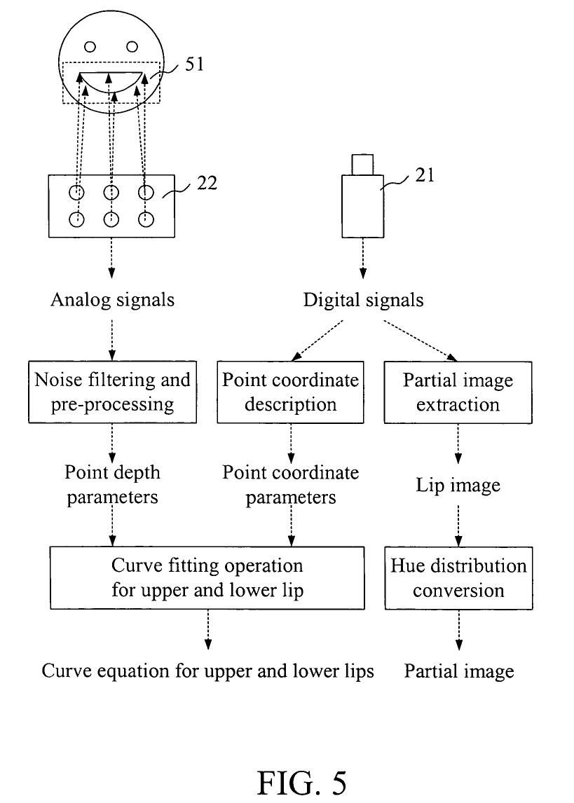

Please refer again to FIG. 3. After receiving the image parameters and the profile parameters of the target image 51, the portable information device 1 analyzes the above parameters to obtain a 3D image and texture information of the target 51 (step 302). Please refer to FIG. 5. FIG. 5 is a schematic drawing of sensing a 3D lip shape according to the embodiment of the present invention. In order to calculate a 3D lip image, the portable information device 1 combines point coordinate parameters provided by the digital information extracted by the image sensor 21, and point depth parameters provided by the analog signals extracted by the deep sensor 22, to perform a curve fitting operation to the upper and lower lips, and thereby obtain a curve equation for the upper and lower lips. This embodiment extracts six datum points to measure the upper and lower lip curves; furthermore, the image sensor 21 extracts an image of a lip area that is lip texture, and the portable information device 1 performs hue distribution conversion, such as brightness and color, to obtain texture information for the lip partial image.

Next, the input module 12 receives an input command from the user (step 303), as shown in FIG. 2. The touch panel of the input module 12 provides a plurality of lip colors; for example, the user may select a color first, and then select a target image 51 to inform the portable information device 1 that the target image 51 needs to be colored by the selected lip color. In this embodiment, every lip color tone is defined with a use effect setting of a corresponding lipstick. Moreover, if the user selects an image that does not match the setting of the makeup parameter, for example, if the user selects a lip color first but then selects an eye image rather than the lip image, the portable information device 1 can ignore such input to decrease system loading.

Accordingly, the portable information device 1 extracts the setting of the corresponding makeup parameter of the selected lip color (step 304). The portable information device 1 performs an image processing operation by utilizing the 3D image, the texture information, and the makeup parameter to obtain a makeup post-application image (step 305). However, some target space parameters (such as color parameters, brightness parameters and saturation parameters of the target space) can also be considered in the processing to provide makeup effects under the specifics of different spaces (ex. at a dinner party event, or under different types of lighting). In step 304, the portable information device 1 reads the makeup parameter from the remote makeup database 3 or the plug-in makeup data extension card 4. If the user wishes to try another series of lip colors, the portable information device 1 simply links to another remote makeup database 3, or another makeup data extension card 4 may be used. Moreover, the remote makeup database 3, or the plug-in makeup data extension card 4, can store various makeup application skills, which define makeup application skill information for the different types of make up. The portable information device 1 can thus select a corresponding makeup application skill parameter according to the makeup selected by the user.

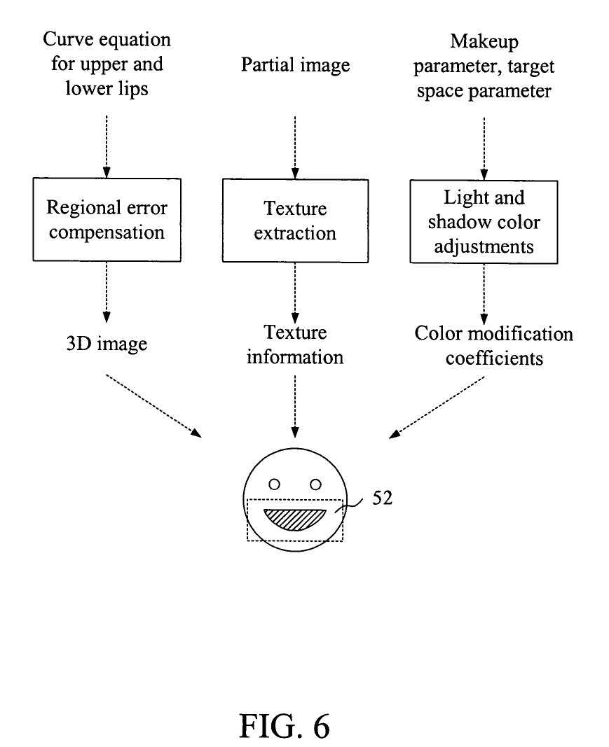

Please refer to FIG. 6. FIG. 6 is a schematic drawing of a virtual 3D lip shape. In step 305, the portable information device 1 performs an image processing operation by utilizing the curve equation for the upper and lower lips, a partial image (the lip image), makeup parameters and makeup application skill parameters, to generate a makeup post-application image 52. The curve equation for the upper and lower lips employs a regional error compensation technique to obtain the 3D image; the partial image employs a texture extraction technique to obtain the texture information; and other adjusting coefficients provide color modification coefficients for light and shadow color adjustments.

Finally, the makeup post-application image 52 is displayed on the display module 11 (step 306). Since the sensor module 2 dynamically and continuously extracts image information, when the user turns his or her face, or moves with respect to the sensor module 2, the target image 51 changes too, and so the portable information device 1 recalculates the target image 51 to obtain a new makeup post-application image (step 307), thereby providing a dynamic, three-dimensional, and multiple viewing angle makeup effect. Moreover, the portable information device 1 can be preset to recalculate the target image 51 when the target image moves beyond a predetermined angle, thereby avoiding excessive data processing loads. Furthermore, the user can store the makeup post-application image 52 in the portable information device 1, or in a memory card (step 308), and then further continue trying other lip colors, or change the target image to an eye area for eye makeup sampling. Since the embodiment simulates different partial images each time, when the user wants to combine the effects of different makeup products, he or she can call up the stored different partial makeup post-application images to obtain a makeup post-application image for the entire face.

According to the above description, the present invention can generate a 3D image corresponding to the target image according to the image data and the depth data provided by the sensor, and then process the 3D image by adding color, lighting and saturation parameters to match different target conditions. Furthermore, the present invention allows provision of a makeup database for different makeup materials, and also provides for a makeup application skill database, to obtain more realistic makeup effects.

Although the present invention has been explained in relation to its preferred embodiment, it is to be understood that many other possible modifications and variations can be made without departing from the spirit and scope of the invention as hereinafter claimed.

1. A simulation method for makeup trial comprising the steps of:
(A) extracting image parameters and profile parameters of a target image;
(B) analyzing image parameters and profile parameters to obtain a 3D image and texture information;
(C) receiving an input command to combine a makeup parameter with the target image, the makeup parameter defining a makeup effect;
(D) extracting a setting for the makeup parameter;
(E) performing an image processing operation to the 3D image by utilizing the texture information and the makeup parameter to obtain a makeup post-application image; and
(F) displaying the makeup post-application image.

2. The method as claimed in claim 1, further comprises dynamically calculating a corresponding makeup post-application image of the target image according to a viewing angle of the target image.

3. The method as claimed in claim 1, wherein in step (A), a point coordinate description technique is used to extract a plurality of point coordinate parameters from digital signals of the target image, and a partial image extraction technique is used to extract a partial image of the target image to form the image parameter.

4. The method as claimed in claim 1, wherein in step (A), a signal filtering and pre-processing technique is used to extract a plurality of point depth parameters from analog signals of the target image to form the profile parameter.

5. The method as claimed in claim 1, wherein step (D) extracts the setting for the makeup parameter from a remote makeup database via a network connection.

6. The method as claimed in claim 1, wherein step (D) extracts the setting for the makeup parameter from a makeup data extension card of the information device.

7. The method as claimed in claim 1, wherein in step (E), an image processing operation is performed by using the 3D image, the texture information, the makeup parameter and a target space parameter, where the target space parameter defines a color parameter, a brightness parameter and a saturation parameter of a target space.

8. The method as claimed in claim 1, wherein in step (E), an image processing operation is performed by using the 3D image, the texture information, the makeup parameter and a makeup application skill parameter, where the makeup application skill parameter defines makeup application skill information related to the makeup parameter.

9. The method as claimed in claim 1 further comprising step (G) after the step (F): storing the makeup post-application image.

10. The method as claimed in claim 1, wherein the target image is a partial facial image of a user.

11. The method as claimed in claim 10 wherein different makeup post-application images formed by different partial images are combined to display a composite makeup post-application image corresponding to a full facial image of the user.

12. The method as claimed in claim 1, wherein the target image is a full facial image of a user.

13. A simulation device for makeup trial comprising:
a display module;
a sensor module for extracting image parameters and profile parameters of a target image;
an input module for inputting a command to combine a makeup parameter with the target image, the makeup parameter defining a makeup effect;
a microprocessor for analyzing the image parameters and the profile parameters to obtain a 3D image and texture information, for performing an image processing operation by utilizing the 3D image, the texture information and the makeup parameter to obtain a makeup post-application image, and for displaying the makeup post-application image on the display module.

14. The device as claimed in claim 13, wherein the sensor module comprises an image sensor for employing a point coordinate description technique to extract a plurality of point coordinate parameters from digital signals of the target image, and for employing a partial image extracting technique to extract a partial image of the target image, to form the image parameter.

15. The device as claimed in claim 13, wherein the sensor module comprises a deep sensor for employing a signal filtering and pre-processing technique to extract a plurality of point depth parameters from analog signals of the target image to form the profile parameter.

16. The device as claimed in claim 13, wherein the sensor module is a plug-in module.

17. The device as claimed in claim 13, wherein the sensor module is embedded in the simulation device for makeup trial.

18. The device as claimed in claim 13, wherein the input module is a touch panel.

19. The device as claimed in claim 13, wherein the microprocessor is capable of extracting the setting for the makeup parameter from a remote makeup database via a network connection.

20. The device as claimed in claim 13 further comprising a makeup data extension card, the microprocessor capable of reading the setting for the makeup parameter from the makeup data extension card.
